(19) United States
(12) Patent Application Publication
(10) Pub. No.: US 2011/0181126 A1
(43) Pub. Date: Jul. 28, 2011

(54) System and device for current measuring, controlling, and heat sinking

(76) Inventors: Jenn-Yang Tien, Hsinchu City (TW); Jan-Wu Hong, Hsinchu City (TW)

(21) Appl. No.: 12/657,738

(22) Filed: Jan. 27, 2010

(51) Int. Cl. H02J 7/00

(52) U.S. Cl. 307/127

(57) ABSTRACT

The present invention provides a system and device for current measuring, controlling, and heat sinking which includes a positive electrode terminal carrier, a positive electrode output terminal carrier, a negative electrode terminal carrier, and a current control circuit carrier. The system and device is to be installed on a battery with high current capacity. In which the output current flowing through the battery's positive electrode is measured by the current measurement device which is installed in the positive electrode terminal carrier. A reverse current control switch and a forward current control switch are installed in the current control circuit carrier to control the current flowing path and the current flowing in the path. Furthermore the heat generated by the circuit is radiated by the current control circuit carrier.

### BACKGROUND OF THE INVENTION

(a) Field of the Invention

This invention provides a system and device for current measuring, controlling, and heat sinking, and more particularly, to one focusing on a battery requiring current controlling, current measuring and heat sinking for large DC current flowing. This invention is to integrate the system functions of current flow controlling, current measurement and heat sink into a device to achieve the purpose of large current control and management for a battery by using only one device.

(b) Description of the Prior Art

Formerly, there was no one system or device designed for solving the issues about large current measurement, current controlling, and heat sinking at the same time as the above-mentioned system and device for a high current capacity battery. The former designs which particularly aimed at solving a single problem or used plural devices in one battery to solve the above-mentioned issues were ineffectiveness and contrarily increase the burden for putting a battery to use.

In view of the foregoing, an objective of this invention is to provide the current measuring, current controlling, and heat sinking in one device to improve high current utility of a battery.

### SUMMARY OF THE INVENTION

The main purpose of the present invention is to provide a system and device for current measuring, controlling, and heat sinking, which includes a positive electrode terminal carrier, a positive electrode output terminal carrier, a negative electrode terminal carrier, and a current control circuit carrier. The system and device is to be installed on a battery with high current capacity. During the process of charge or discharge the battery, this invention achieves the purpose of current measuring, current controlling, and the heat sink function of the circuit.

### BRIEF DESCRIPTION OF THE DRAWINGS

FIG. 1 is the system diagram of this invention.

FIG. 2 is the positive electrode terminal carrier diagram of this invention.

FIG. 3 is the embodiment diagram of this invention.

### DETAILED DESCRIPTION OF THE PREFERRED EMBODIMENTS

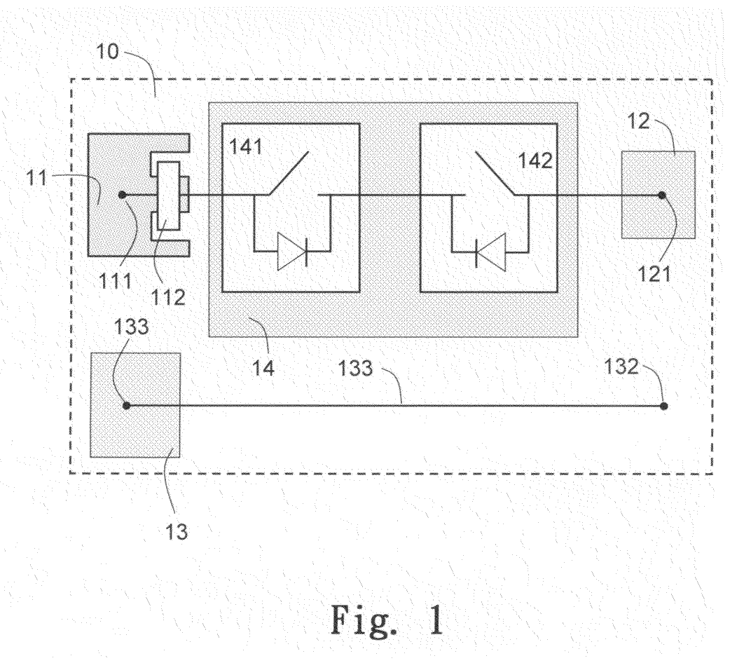

Please refer to FIG. 1 for the system diagram. The system and device for current measuring, controlling, and heat sinking (10) of present invention is composed of a positive electrode terminal carrier (11), a positive electrode output terminal carrier (12), a negative electrode terminal carrier (13), and a current control circuit carrier (14).

As shown in the diagram, the positive electrode terminal carrier (11) is a conducting metal to be a conducting path for the current. There is a positive electrode terminal (111) and a current measurement device (112) on this carrier. This positive electrode terminal (111) is the joint location for the positive electrode terminal carrier (11) and the positive electrode of the battery. The current measurement device (112) is a kind of current loop surrounding the positive electrode terminal (111) to measure the current flowing in and out of the positive electrode of the battery.

The positive electrode output terminal carrier (12) is a conducting metal to be a conducting path for the current. There is a positive electrode output terminal (121) on this carrier which is the current output terminal and which shape can be design in accordance with the mold required of the battery's positive electrode.

The negative electrode terminal carrier (13) is a conducting metal to be a conducting path for the current. There is a negative electrode terminal (131) on this carrier which is the joint location for the negative electrode terminal carrier (13) and the negative electrode of the battery. A negative electrode conducting wire (133) is connected from the negative electrode terminal (131) to the negative electrode output terminal (132). The negative electrode conducting wire (133) and the negative electrode output terminal (132) are the returning path for the current and can be a metal extended from the negative electrode terminal carrier (13).

The current control circuit carrier (14) is a conducting metal to be a conducting path for the current. This carrier is a designed metal cast which functions as a heat sink of the circuit system. There is a reverse current control switch (141) and a forward current control switch (142) installed on this carrier. The reverse current control switch (141) and the forward current control switch (142) are composed of MOSFETs.

As foregoing reverse current control switch (141), the source terminal of the switch is bonded to the positive electrode terminal carrier (11) and the drain terminal to the current control circuit carrier (14). And the source terminal of the foregoing forward current control switch (142) is bonded to the positive electrode output terminal carrier (12) and the drain terminal to the current control circuit carrier (14).

The reverse current control switch (141) and the forward current control switch (142) can receive and be controlled by an external controlling signal. When the reverse current control switch (141) is opened, the flowing path of reverse current is cutoff. When the forward current control switch (142) is opened, the flowing path of forward current is cutoff.

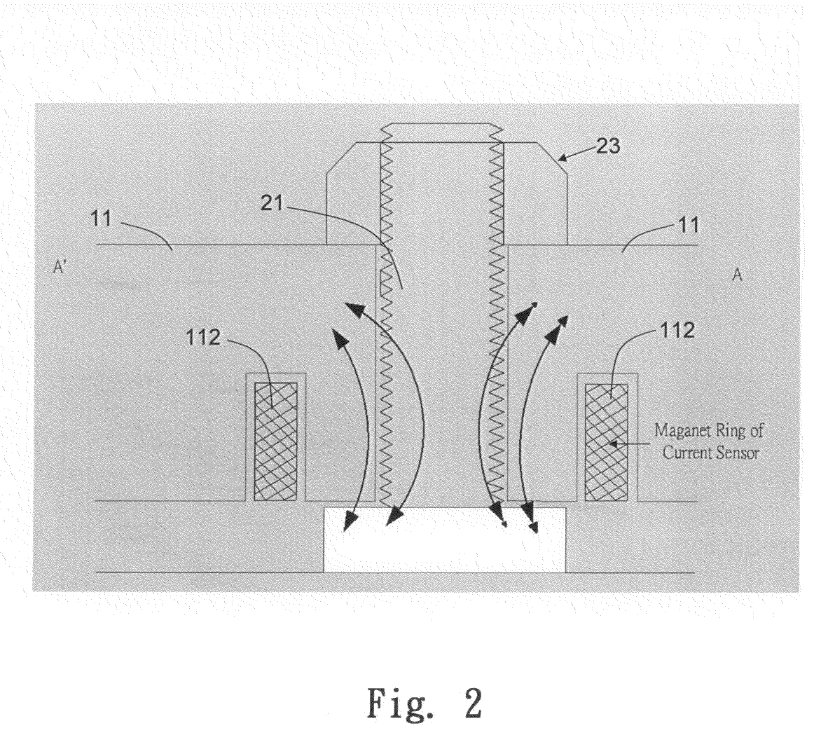

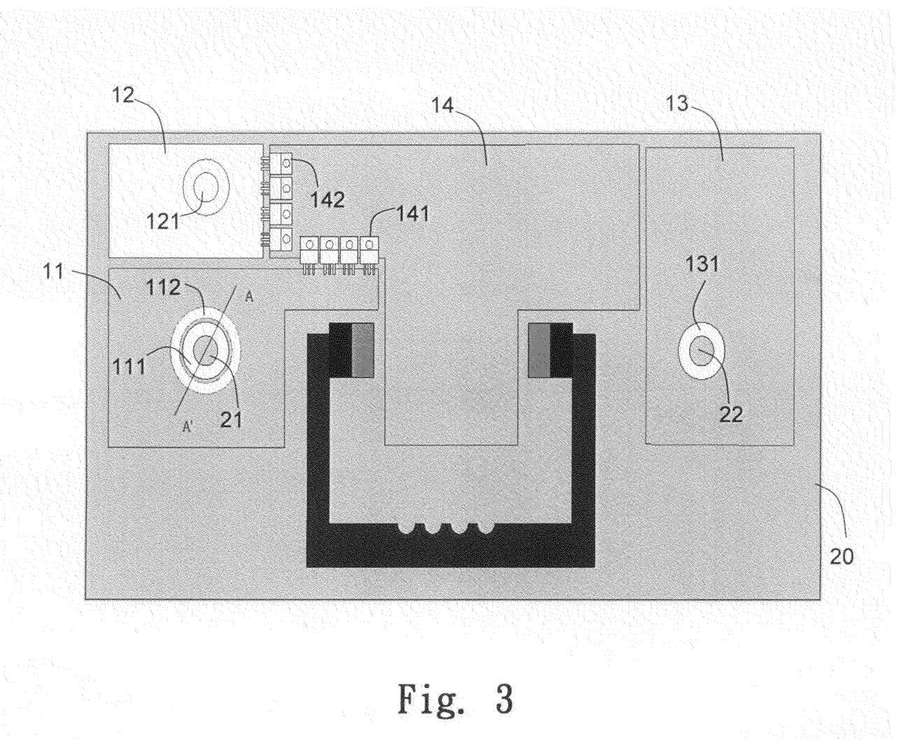

Please refer to FIG. 2 and FIG. 3. Take the charging and discharging current control process of the Group 31 battery (20) for example to illustrate the best embodiment of the present invention. The system and device for current measuring, controlling, and heat sinking (10) is installed onto the top of the Group 31 battery (20). As showing in the drawings, the positive electrode (21) of the Group 31 battery (20) is bonded to the positive electrode terminal (111) on the positive electrode terminal carrier (11) of the system and device for current measuring, controlling, and heat sinking (10) and fastened by a fastening component (23). In the same way, the negative electrode (22) of the Group 31 battery (20) is bonded to the negative electrode terminal (131) on the negative electrode terminal carrier (13) of the system and device for current measuring, controlling, and heat sinking (10) and fastened by a fastening component (23).

When the Group 31 battery (20) is being charging or discharging, the positive electrode terminal carrier (11), the positive electrode output terminal carrier (12), the negative electrode terminal carrier (13), and the current control circuit carrier (14) of the system and device for current measuring, controlling, and heat sinking (10) is the charging or discharging current conducting path for this battery. In which, the current measurement device (112) installed on the positive electrode terminal carrier (11) will measure the amount current flowing through the positive electrode (21) of the Group 31 battery (20). The reverse current control switch (141) and the forward current control switch (142) installed on the current control circuit carrier (14) can perform the conducting or cutoff functions of the current path in accordance with the external control signal received to control the current flowing in or out of the Group 31 battery (20) during the phase of charging or discharging. Because heat will be generated during the charge or discharge process, the heat can be radiated itself by the designed metal structure of the current control circuit carrier (14).

1. A system and device for current measuring, controlling, and heat sinking, which includes:
a positive electrode terminal carrier set with a positive electrode terminal and a current measurement device mainly be installed on the positive electrode of a battery and the amount current of the positive electrode is measured by the current measurement device;
a positive electrode output terminal carrier set with a positive electrode output terminal;
a negative electrode terminal carrier set with a negative electrode terminal and a negative electrode conducting wire connecting the negative electrode terminal to the negative electrode output terminal;
a current control circuit carrier set with a reverse current control switch and a forward current control switch to control the current flowing by the control of the conducting or cutoff of the current path; In which, the drain terminal of the reverse current control switch is connected to the current control circuit carrier and the source terminal of the reverse current control switch is connected to positive electrode terminal carrier; The drain terminal of the forward current control switch is connected to the current control circuit carrier and the source terminal of the forward current control switch is connected to positive electrode output terminal carrier.

2. The system and device for current measuring, controlling, and heat sinking as claimed in claim 1, wherein the positive electrode terminal carrier, the positive electrode output terminal carrier, the negative electrode terminal carrier, and the current control circuit carrier are all metal conductors to be current conducting paths.

3. The system and device for current measuring, controlling, and heat sinking as claimed in claim 1, wherein the current measurement device is installed and surrounded the electrode terminal.

4. The system and device for current measuring, controlling, and heat sinking as claimed in claim 1, wherein the reverse current control switch and the forward current control switch are all composed of MOSFETs.

5. The system and device for current measuring, controlling, and heat sinking as claimed in claim 1, wherein the negative electrode output terminal and negative electrode conducting wire can be the metal extended from the negative electrode terminal carrier.

6. The system and device for current measuring, controlling, and heat sinking as claimed in claim 1 and claim 2, wherein the current control circuit carrier is a heat sink designed to radiate the heat generated by the circuit.

7. The system and device for current measuring, controlling, and heat sinking as claimed in claim 1 and claim 4, wherein the reverse current control switch can be controlled by external signals; when the reverse current control switch is opened, the reverse current conducting path can be cutoff.

8. The system and device for current measuring, controlling, and heat sinking as claimed in claim 1 and claim 4, wherein the forward current control switch can be controlled by external signals; when the forward current control switch is opened, the forward current conducting path can be cutoff.
